(19) United States
(12) Patent Application Publication
(10) Pub. No.: US 2025/0336302 A1
(43) Pub. Date: Oct. 30, 2025

(54) SYSTEM AND METHOD FOR MANAGING AERONAUTICAL DATA FOR FLIGHT PLANS OF AIRCRAFT

(71) Applicant: THE BOEING COMPANY, Arlington, VA (US)

(72) Inventor: Christopher Collyard, Littleton, CO (US)

(73) Assignee: THE BOEING COMPANY, Arlington, VA (US)

(21) Appl. No.: 18/650,692

(22) Filed: Apr. 30, 2024

(51) Int. Cl. G08G 5/00

(52) U.S. Cl. CPC G08G 5/34; G08G 5/22; G08G 5/26

(57) ABSTRACT

A system and method include a communication device, and a control unit is communication with the communication device. The control unit is configured to receive, via the communication device, an issue signal including information regarding an issue in relation to a flight plan for an aircraft, compare the issue with data from one or more flight information sources to automatically validate the issue, and, in response to the issue being automatically validated, automatically update the flight plan based on the issue to provide an updated flight plan.

### FIELD OF THE DISCLOSURE

Examples of the present disclosure generally relate to systems and methods for managing aeronautical data for flight plans of aircraft.

### BACKGROUND OF THE DISCLOSURE

Aircraft are used to transport passengers and cargo between various locations. Numerous aircraft depart from and arrive at a typical airport every day.

An aircraft is flown from a departure airport to an arrival airport according to a defined flight plan, which includes altitudes, headings, airspeeds, and the like along a particular path. As a pilot operates the aircraft according to the flight plan, the pilot may determine that certain aspects of the flight plan may differ from actual flight operations, and/or may pose confusion. As an example, a pilot may notice that a map of the flight plan indicates an upper limit of an altitude at a certain location, which differs from observation during a flight. As another example, the flight map can include overlapping airspaces having different upper or lower limits. As another example, the pilot may notice that the flight plan provides a flight heading or bearing having an inconsistency in relation to a route the aircraft is actually being flown.

When such discrepancies are observed, the pilot typically contacts one or more individuals who oversee flight operations to inform them of the discrepancies. The individuals then review the flight plan, and can correct the flight plan if necessary. As can be appreciated, the process of contacting individuals regarding discrepancies, such as through telephone, email, or the like, and then manually correcting the discrepancies, is time consuming. Further, the flight plan may be subsequently updated days, weeks, or even months later.

### SUMMARY OF THE DISCLOSURE

A need exists for a system and a method for efficiently and effectively updating aeronautical data for flight plans of aircraft. Further, a need exists for a system and a method for automatically updating the aeronautical data. Additionally, a need exists for a system and a method for quickly updating a flight plan.

With those needs in mind, certain examples of the present disclosure provide a system including a communication device, and a control unit in communication with the communication device. The control unit is configured to receive, via the communication device, an issue signal including information regarding an issue in relation to a flight plan for an aircraft, compare the issue with data from one or more flight information sources to automatically validate the issue, and, in response to the issue being automatically validated, automatically update the flight plan based on the issue to provide an updated flight plan.

The aircraft is configured to be operated according to the updated flight plan. In at least one example, the aircraft includes a user interface including a display in communication with an input device. The issue is input by a pilot of the aircraft via the user interface.

In at least one example, the one or more flight information sources include one or more of a tracking sub-system configured to track the aircraft; a weather sub-system configured to provide past, current, and predicted weather; aircraft data sources configured to provide information about the aircraft; or a historical database configured to provide data regarding issues reported from one or both of the aircraft or other aircraft. In at least one further example, the one or more flight information sources include the tracking sub-system, the weather sub-system, the aircraft data sources, and the historical database. The tracking sub-system can be an automatic dependent surveillance-broadcast (ADS-B) tracking sub-system. The aircraft data sources can provide tail-specific information regarding the aircraft.

In at least one example, the control unit is an artificial intelligence or machine learning system.

The aircraft can be automatically operated according to the updated flight plan. For example, the control unit can be further configured to automatically operate the aircraft according to the updated flight plan.

Certain examples of the present disclosure provide a method including communicatively coupling a control unit with a communication device; receiving, by the control unit via the communication device, an issue signal including information regarding an issue in relation to a flight plan for an aircraft; comparing, by the control unit, the issue with data from one or more flight information sources to automatically validate the issue; and, in response to the issue being automatically validated, automatically updating the flight plan based on the issue to provide an updated flight plan.

### BRIEF DESCRIPTION OF THE DRAWINGS

FIG. 1 illustrates a block diagram of a system, according to an example of the present disclosure.

FIG. 2 illustrates a simplified flight plan, according to an example of the present disclosure.

FIG. 3 illustrates a front view of a display showing a map, according to an example of the present disclosure.

FIG. 4 illustrates a flow chart of a method, according to an example of the present disclosure.

FIG. 5 illustrates a schematic block diagram of a control unit, according to an example of the present disclosure.

FIG. 6 illustrates a perspective front view of an aircraft, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

Examples of the present disclosure provide systems and methods for updating and/or supplementing aeronautical data for flight plans. In at least one example, the systems and methods include a control unit that receives inputs from pilots regarding aeronautical data for flight plans. For example, the pilot notices an issue between aeronautical data for a flight plan and actual observations during operation of an aircraft. The issue can include a discrepancy or difference (such as an altitude, heading, and/or airspeed indicated in the flight plan differing from actual operation of the aircraft during a flight), supplemental information (such as an informative note regarding potential confusion between overlapping airspaces), and/or the like. The pilot inputs the issue through a user interface. The control unit receives the input including the data regarding the issue. The control unit then automatically analyzes the noted issue, input by the pilot, with one or more sources to validate the issue. Once validated, the control unit then automatically (without human intervention) updates (such as revises, corrects, and/or the like) the aeronautical data of the flight plan. The control unit receives inputs from various pilots of various aircraft to automatically analyze and update aeronautical data of flight plans. In this manner, examples of the present disclosure provide systems and methods for automatically updating aeronautical data based on crowd-sources feedback.

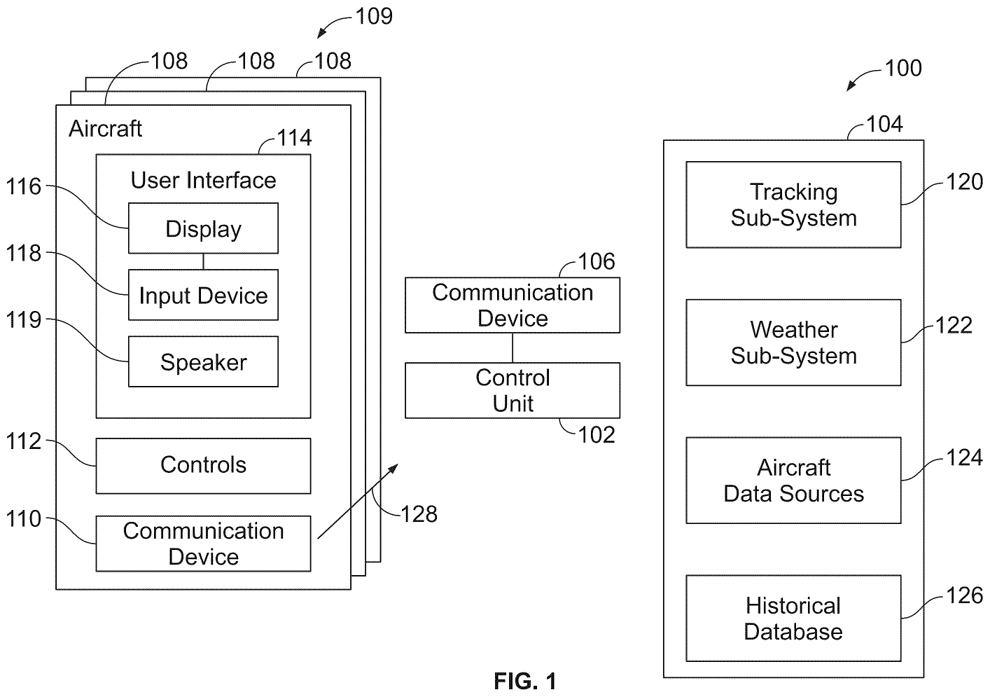

FIG. 1 illustrates a block diagram of a system 100, according to an example of the present disclosure. The system 100 includes a control unit 102 in communication with a plurality of flight information sources 104, such as through one or more wired or wireless connections. For example, the control unit 102 can be coupled to a communication device 106 that receives data from the flight information sources 104. The communication device 106 can be one or more of an antenna, a transceiver, an internet connection, a cloud-based connection, and/or the like.

The control unit 102 is also in communication with one or more aircraft 108 within an airspace 109, such as via communication between the communication device 106 and a communication device 110 of each aircraft 108. The communication device 110 can be an antenna, a transceiver, an internet connection, a cloud-based connection, and/or the like. In at least one example, the control unit 102 is separate and distinct from the aircraft 108. For example, the control unit 102 can be located at a central monitoring location, which can be remote from, or optionally co-located with, one or more of the flight information sources 104. As another example, the control unit 102 can be onboard the aircraft 108, such as within a flight deck or cockpit. For example, the control unit 102 can be part of a flight computer of the aircraft 108.

The aircraft 108 includes controls 112 configured to allow an operator, such as a pilot, to control operation of the aircraft 108. For example, the controls 112 include one or more of a control handle, yoke, joystick, control surface controls, accelerators, decelerators, and/or the like.

The aircraft 108 also includes one or more user interfaces 114. For example, a user interface 114 can be within a flight deck or cockpit of the aircraft 108. In at least one example, a user interface 114 includes a display 116 and an input device 118. In at least one example, the display 116 is an electronic device configured to electronically show images, videos, text, and/or the like. The display 116 can be a monitor, screen, television, touchscreen, and/or the like. The input device 118 can include a keyboard, mouse, stylus, touchscreen interface (that is, the input device 118 can be integral with the display 116), and/or the like. The display 116 is configured to show visual graphics, videos, text, and/or the like. The user interface 114 can also include a speaker 119, which is configured to broadcast audio messages. The user interface 114 can be, or part of, a computer workstation. For example, the user interface 114 can be part of the flight computer within the flight deck or cockpit of the aircraft 108. As another example, the user interface 114 can be a handheld device, such as a smart phone, tablet, or the like.

In at least one example, the control unit 102 can be in communication with a user interface 114 that is not onboard an aircraft 108, in addition to (or optionally instead of) the user interface 114 onboard one or more aircraft 108. For example, the user interface 114 can be at a land-based monitoring location, such as with respect to air traffic control, a flight dispatcher, an airline operations center, and/or the like.

The control unit 102 receives data from the flight information sources 104. The data includes vast amounts of information from numerous different flight information sources 104. The flight information sources 104 include a tracking sub-system 120, which is configured to track the various aircraft 108 on the ground and in the airspace 109. In at least one example, the tracking sub-system 120 is configured to track positions of the aircraft 108 in real time. In at least one example, the tracking sub-system 120 is a radar sub-system. As another example, the tracking sub-system is an automatic dependent surveillance-broadcast (ADS-B) tracking sub-system. Real time positions of the aircraft 108 on the ground and within an airspace are detected by the tracking sub-system 120 that receives position signals output by position sensors of the aircraft 108. For example, the tracking sub-system 120 receives ADS-B signals output by the position sensors of the aircraft 108. As another example, the position sensors of the aircraft 108 can be global positioning system sensors. The position sensors output signals indicative of one or more of the position, altitude, heading, acceleration, velocity, and/or the like of the aircraft 108. The signals are received by the tracking sub-system 120.

The flight information sources 104 can also include a weather sub-system 122, which provides past, current, and predicted weather for locations of the aircraft 108, airports, and the like. As an example, the weather sub-system 122 can include a weather station, channel, or the like. As another example, the weather sub-system 122 can include aeronautical weather services that provide weather notifications at various locations, such as airports. An example of data from a weather sub-system 122 includes a meteorological aerodrome report (METAR). The weather sub-system 122 detects current weather conditions within the airspace 109, such as air temperatures, wind speeds and directions, air pressure, precipitation, and the like within the airspace 109.

The flight information sources 104 can also include aircraft data sources 124, which provide information about the various aircraft. For example, the aircraft data sources 124 include information regarding a type, size, shape, and capabilities of the aircraft 108. The aircraft data sources 124 can be information provided by a manufacturer, maintenance provider, operator, and/or the like of the aircraft 108.

In at least one example, the aircraft data sources 124 can provide tail-specific information regarding the aircraft 108. The tail-specific information for the aircraft 108 provides information regarding the performance of the specific, actual aircraft, in contrast to a different test aircraft, a general performance model, or the like. Optionally, the aircraft data sources 124 can provide general information regarding the type of aircraft 108.

The flight information sources 104 also include a historical database 126. The control unit 102 is in communication with the historical database 126, such as through one or more wired or wireless connections. The historical database 126 stores data previously reported from various aircraft 108. The data includes information regarding issues with respect to aeronautical data (such as locations and altitudes of particular airspaces, airspeeds for aircraft, headings and bearings for aircraft, and the like) for flight plans of the aircraft 108. In at least one example, the issues include a discrepancy or difference (such as an altitude, heading, and/or airspeed indicated in the flight plan differing from actual operation of the aircraft during a flight), supplemental information (such as an informative note regarding potential confusion between overlapping airspaces), and/or the like.

As described herein, the system 100 includes the control unit 102, which is configured to receive the issue signal 128 including information regarding an issue in relation to a flight plan for an aircraft 108. The control unit 102 is further configured to compare the issue with one or more flight information sources 104 to automatically validate the issue. In response to the issue being automatically validated, the control unit 102 is further configured to automatically update the flight plan based on the issue to provide an updated flight plan. The aircraft is operated according to the updated flight plan. In at least one example, the issue is input by a pilot of the aircraft 108 via the user interface 114.

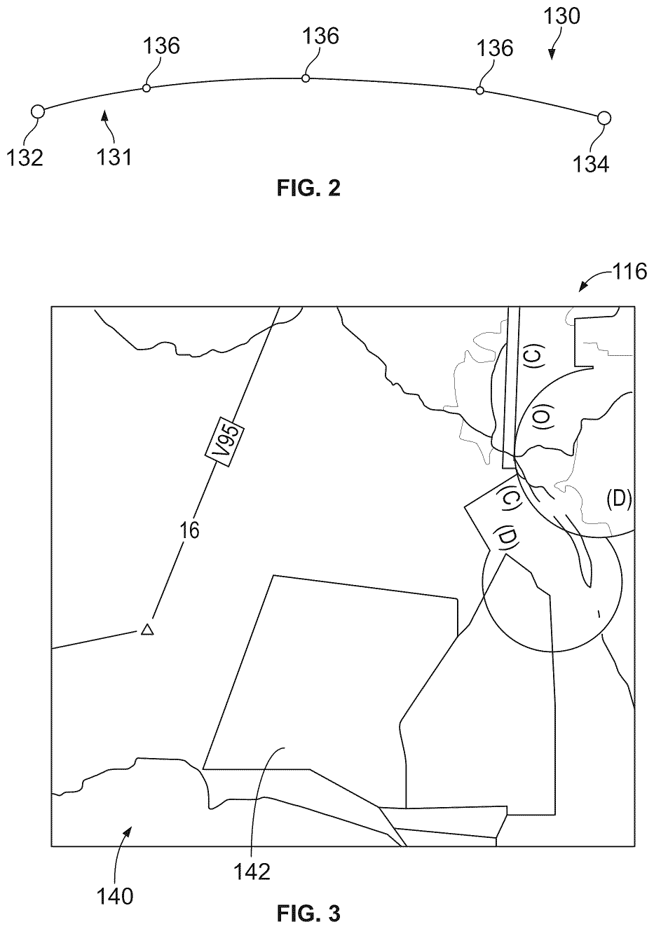

FIG. 2 illustrates a simplified flight plan 130, according to an example of the present disclosure. The flight plan 130 includes a flight path 131 between a departure airport 132 and an arrival airport 134. The flight path 131 can include one or more waypoints 136 between the departure airport 132 and the arrival airport 134. The flight plan 130 includes airspeeds, headings, altitudes, and the like at the locations between the departure airport 132 and the arrival airport 134.

FIG. 3 illustrates a front view of a display 116 showing a map 140, according to an example of the present disclosure. The map 140 shows a region 142 of an airspace. Referring to FIGS. 1-3, the flight plan 130 may indicate an upper limit of an altitude to be a particular magnitude. However, during a flight, a pilot may observe the upper limit differs from the magnitude noted in the flight plan 130. As such, the difference in magnitude is an example of an issue that the pilot may note.

An aircraft 108 is operated according to the flight plan 130 to fly from the departure airport 132 and the arrival airport 134. During the flight, a pilot of the aircraft 108 may notice an issue between the flight plan 130 and observations during the flight. For example, the pilot may notice that actual operation of the aircraft 108 at a particular location within the flight plan, such as at a waypoint 136, should be at an altitude that differs from the altitude indicated in the flight plan. As another example, the pilot may notice confusion within the flight plan 130 between overlapping airspaces, and during the flight, may notice how the confusion can be alleviated. As another example, the pilot may notice that a bearing within the flight plan 130 at a particular waypoint differs from the bearing of the aircraft during actual operation of the aircraft 108. As another example, the pilot may notice that a certain portion of the flight plan 130 can extend into, or be adjacent to, restricted airspace.

In response to noticing an issue, the pilot operates the user interface 114 to input the issue. For example, the pilot may use the input device 118 to provide the issue to the control unit 102. The user interface 114 outputs an issue signal 128 (for example, an electronic signal) including information regarding the issue input by the pilot. The issue signal 128 is sent by the communication device 110 of the aircraft 108, and received by the communication device 106. The control unit 102 then receives the issue signal 128. The control unit 102 then automatically analyzes (without human intervention) the information regarding the issue within the issue signal 128.

In at least one example, the control unit 102 compares the issue with the flight plan 130 to determine if the flight plan 130 is to be updated. For example, the control unit 102 may determine the issue indicates a discrepancy with the flight plan 130. As another example, the control unit 102 may determine the issue provides supplemental information (such as a helpful note regarding possible confusion regarding overlapping airspaces).

In response to determining the issue with the flight plan 130 (as received from the issue signal 128), the control unit 102 automatically compares the issue with data from one or more of the flight information sources 104. For example, the control unit 102 compares the issue with tracked data of one or more aircraft 108 output by the tracking sub-system 120 to determine if the issue conforms to the tracked data. As an example, the issue may indicate a particular airspeed at a particular altitude. If the issue and the tracked data conform to one another, the control unit 102 may then automatically validate (without human intervention) the issue, and then automatically update the flight plan with the information included in the issue. If, however, the airspeed and altitude do not conform to the tracked data (such as an altitude above a defined upper limit), the control unit 102 refrains from validating the issue, and refrains from updating the flight plan 130.

As another example, the control unit 102 can validate the issue based on weather data received from the weather sub-system 122. For example, the issue may indicate a heading that directs the aircraft 108 around hazardous weather (such as inclement weather, high winds, or the like). The control unit 102 may automatically validate the issue and automatically update the flight plan 130 accordingly.

As another example, the control unit 102 can validate the issue based on aircraft data received from the aircraft data sources 124. For example, the issue may indicate an airspeed that may not be efficient for the particular aircraft 108. The control unit 102 may refrain from validating the issue if the airspeed noted in the issue is inefficient. If, however, the airspeed and/or altitude are efficient or otherwise allowable based on the aircraft data, the control unit 102 may automatically update the flight plan based on the issue.

As another example, the control unit 102 can compare the issue with historical data within the historical database 126. The historical data can include issues previously input by pilots of aircraft 108. The control unit 102 may validate the issue and update the flight plan in response to a determination that the issue was previously input by the pilots, and stored in the historical database 126, such as a predetermined number of times. That is, the control unit 102 may refrain from updating the flight plan 130 in response to receiving the issue the first time. The control unit 102 may validate and update the issue based on a predetermined number of times (such as two, three, four, five or more times) the issue has been received from the aircraft 108. In this manner, the control unit 102 can validate the issue and update the flight plan 130 accordingly based on crowd-sourced data.

In at least one example, the control unit 102 can validate issues and update flight plans 130 via artificial intelligence or machine learning. For example, the control unit 102 can be an artificial intelligence control unit 102.

The aircraft 108 is operated according to the updated flight plan 130. For example, after the flight plan 130 is updated based on the issue(s) received from one or more of the aircraft 108, the aircraft 108 is flown according to the updated flight plan 130. In at least one example, the controls 112 of the aircraft 108 are automatically operated according to the updated flight plan 130. That is, the aircraft 108 can be automatically operated according to the updated flight plan 130. In at least one example, the control unit 102 can automatically operate the controls 112 of the aircraft 108 to automatically control the aircraft 108 according to an updated flight plan. As another example, another control unit onboard the aircraft 108 can automatically operate the controls 112 to automatically control the aircraft 108 according the updated flight plan.

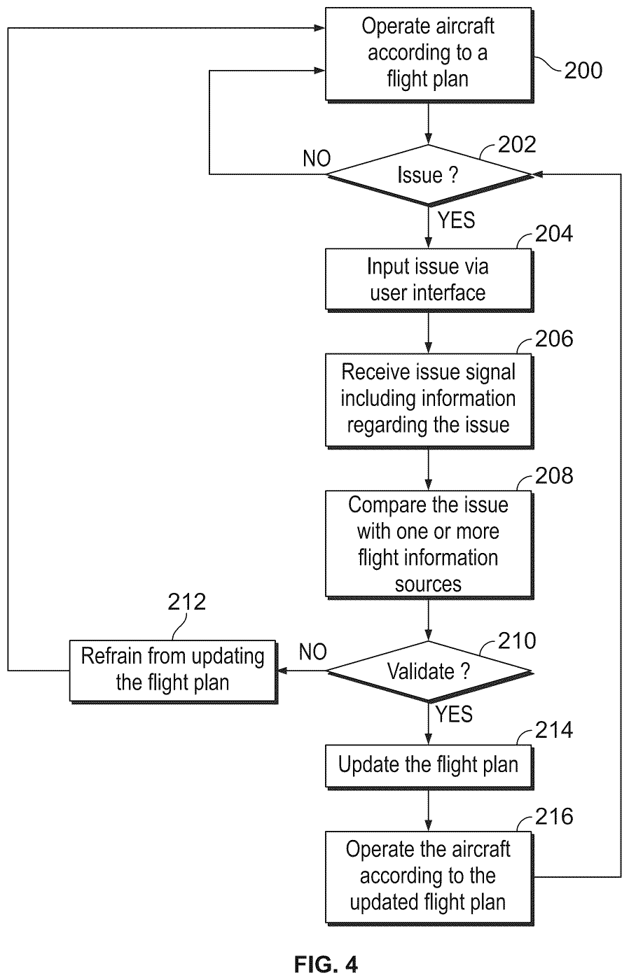

FIG. 4 illustrates a flow chart of a method, according to an example of the present disclosure. Referring to FIGS. 1-4, at 200, an aircraft 108 is operated according to a flight plan 130. At 202, during operation of the aircraft 108, a pilot determines if an issue exists between the actual flight of the aircraft 108, and the flight plan 130. If there is no issue, the method returns to 200.

If, however, an issue arises, the method proceeds from 202 to 204, at which the pilot inputs the issue via the user interface 114 (such as via the input device 118). At 206, the control unit 102 receives an issue signal 128 including information regarding the issue. At 208, the control unit 102 compares the issue with data from one or more flight information sources 104. Based on the comparison, the control unit 102 determines whether or not to automatically (without human intervention) validate the issue at 210. If the control unit 102 does not validate the issue at 210, the method proceeds to 212, at which the control unit 102 refrains from updating the flight plan 130. The method then returns to 200.

If, however, the control unit 102 validates the issue at 210, the method proceeds to 214, at which the control unit 102 automatically (without human intervention) updates the flight plan 130 to provide an updated flight plan 130. The method then proceeds to 216, at which the aircraft 108 is operated according to the updated flight plan 130. The method can then return to 202.

As described herein, examples of the present disclosure provide a crowd sourced data collection, association, and distribution system for correcting and supplementing geospatial data, specifically for aeronautical data of flight plans. The systems and methods described herein allow operators of aircraft 108 to provide data corrections to published data as well as quickly and easily share real-time data (observations, notifications of inaccuracies, etc.) within others. In at least one example, the control unit 102 can analyze the issue(s) through artificial intelligence and machine learning.

The systems and methods described herein allow for correction of discrepancies within aeronautical data of flight plans, and also sharing of important data regarding flight plans. Sharing of such information with the airline community increases the safety of flight, and can also aid in early detection of necessary changes to flight patterns, diversions, etc.

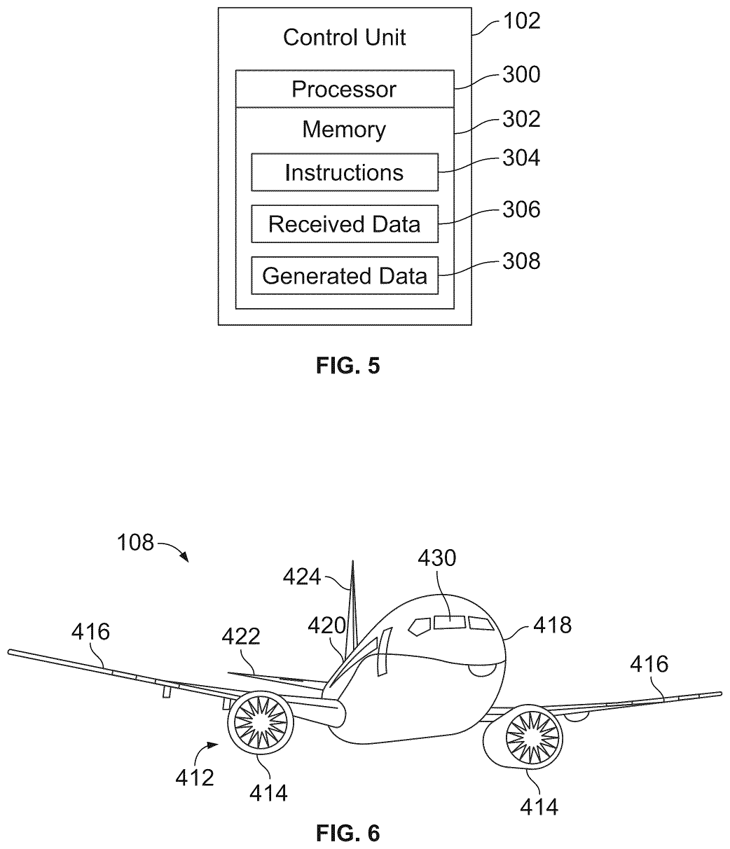

FIG. 5 illustrates a schematic block diagram of the control unit 102, according to an example of the present disclosure. In at least one example, the control unit 102 includes at least one processor 300 in communication with a memory 302. The memory 302 stores instructions 304, received data 306, and generated data 308. The control unit 102 shown in FIG. 5 is merely exemplary, and non-limiting.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 102 may be or include one or more processors that are configured to control operation, as described herein.

The control unit 102 is configured to execute a set of instructions that are stored in one or more data storage units or elements (such as one or more memories), in order to process data. For example, the control unit 102 may include or be coupled to one or more memories. The data storage units may also store data or other information as desired or needed. The data storage units may be in the form of an information source or a physical memory element within a processing machine.

The set of instructions may include various commands that instruct the control unit 102 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the control unit 102. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 102 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

Referring to FIGS. 1-5, examples of the subject disclosure provide systems and methods that allow large amounts of data to be quickly and efficiently analyzed by a computing device. For example, the control unit 102 can receive and analyze data from hundreds, thousands, or more aircraft 108 and flight information sources 104. As such, large amounts of data, which may not be readily discernable by human beings, are being tracked and analyzed. The vast amounts of data are efficiently organized and/or analyzed by the control unit 102, as described herein. The control unit 102 analyzes the data in a relatively short time in order to quickly and efficiently determine and validate issues, and update flight plans 130 accordingly. As such, examples of the present disclosure provide increased and efficient functionality, and vastly superior performance in relation to a human being reviewing the vast amounts of data.

In at least one example, components of the system 100, such as the control unit 102, provide and/or enable a computer system to operate as a special computer system for managing flight plans 130. The control unit 102 improves upon standard computing devices by determining such information and automatically communicating with individuals (such as operators of aircraft) in an efficient and effective manner.

In at least one example, the control unit 102 uses machine learning algorithms which automatically consider factors that influence various aspects of flight plans 130. In at least one example, all or part of the systems and methods described herein are or otherwise include an artificial intelligence (AI) or machine-learning system that can automatically perform the operations of the methods also described herein. In at least one example, the control unit 102 can be or otherwise include a deterministic or rules based evaluation system. In at least one example, the control unit 102 can be an artificial intelligence or machine learning system. These types of systems may be trained from outside information and/or self-trained to repeatedly improve the accuracy with how data is analyzed to validate issues and updated flight plans 130. Over time, these systems can improve by determining and communicating with increasing accuracy and speed, thereby significantly reducing the likelihood of any potential errors. For example, the AI or machine-learning systems can learn and determine models, associate such models with received data, and determine potential conflicts. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), and/or the like. The systems may be trained and re-trained using feedback from one or more prior analyses of the data, ensemble data, and/or other such data. Based on this feedback, the systems may be trained by adjusting one or more parameters, weights, rules, criteria, or the like, used in the analysis of the same. This process can be performed using the data and ensemble data instead of training data, and may be repeated many times to repeatedly improve the determinations and communications described herein. The training minimizes conflicts and interference by performing an iterative training algorithm, in which the systems are retrained with an updated set of data, and based on the feedback examined prior to the most recent training of the systems. This provides a robust analysis model that can better determine issue validation, and determine when to automatically update flight plans.

FIG. 6 illustrates a perspective front view of an aircraft 108, according to an example of the present disclosure. The aircraft 108 includes a propulsion system 412 that includes engines 414, for example. Optionally, the propulsion system 412 may include more engines 414 than shown. The engines 414 are carried by wings 416 of the aircraft 108. In other examples, the engines 414 may be carried by a fuselage 418 and/or an empennage 420. The empennage 420 may also support horizontal stabilizers 422 and a vertical stabilizer 424. The fuselage 418 of the aircraft 108 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like. FIG. 6 shows an example of an aircraft 108. It is to be understood that the aircraft 108 can be sized, shaped, and configured differently than shown in FIG. 6.

Further, the disclosure comprises examples according to the following clauses:

Clause 1. A system comprising:
a communication device; and
a control unit in communication with the communication device, wherein the control unit is configured to:
   receive, via the communication device, an issue signal including information regarding an issue in relation to a flight plan for an aircraft,
   compare the issue with data from one or more flight information sources to automatically validate the issue, and
   in response to the issue being automatically validated, automatically update the flight plan based on the issue to provide an updated flight plan.

Clause 2. The system of Clause 1, wherein the aircraft is configured to be operated according to the updated flight plan.

Clause 3. The system of Clauses 1 or 2, wherein the aircraft comprises a user interface including a display in communication with an input device, wherein the issue is input by a pilot of the aircraft via the user interface.

Clause 4. The system of any of Clauses 1-3, wherein the one or more flight information sources comprise one or more of:
a tracking sub-system configured to track the aircraft;
a weather sub-system configured to provide past, current, and predicted weather;
aircraft data sources configured to provide information about the aircraft; or
a historical database configured to provide data regarding issues reported from one or both of the aircraft or other aircraft.

Clause 5. The system of Clause 4, wherein the one or more flight information sources comprise the tracking sub-system, the weather sub-system, the aircraft data sources, and the historical database.

Clause 6. The system of Clause 5, wherein the tracking sub-system is an automatic dependent surveillance-broadcast (ADS-B) tracking sub-system.

Clause 7. The system of Clauses 5 or 6, wherein the aircraft data sources provide tail-specific information regarding the aircraft.

Clause 8. The system of any of Clauses 1-7, wherein the control unit is an artificial intelligence or machine learning system.

Clause 9. The system of any of Clauses 1-8, wherein the aircraft is automatically operated according to the updated flight plan.

Clause 10. The system of Clause 9, wherein the control unit is further configured to automatically operate the aircraft according to the updated flight plan.

Clause 11. A method comprising:
communicatively coupling a control unit with a communication device;
receiving, by the control unit via the communication device, an issue signal including information regarding an issue in relation to a flight plan for an aircraft;
comparing, by the control unit, the issue with data from one or more flight information sources to automatically validate the issue; and
in response to the issue being automatically validated, automatically updating the flight plan based on the issue to provide an updated flight plan.

Clause 12. The method of Clause 11, further comprising operating the aircraft according to the updated flight plan.

Clause 13. The method of Clauses 11 or 12, further comprising inputting, via a user interface of the aircraft, the issue by a pilot of the aircraft.

Clause 14. The method of any of Clauses 11-13, wherein the one or more flight information sources comprise one or more of:
a tracking sub-system configured to track the aircraft;
a weather sub-system configured to provide past, current, and predicted weather;
aircraft data sources configured to provide information about the aircraft; or
a historical database configured to provide data regarding issues reported from one or both of the aircraft or other aircraft.

Clause 15. The method of Clause 14, wherein the one or more flight information sources comprise the tracking sub-system, the weather sub-system, the aircraft data sources, and the historical database.

Clause 16. The method of Clause 15, wherein the tracking sub-system is an automatic dependent surveillance-broadcast (ADS-B) tracking sub-system, and wherein the aircraft data sources provide tail-specific information regarding the aircraft.

Clause 17. The method of any of Clauses 11-16, wherein the control unit is an artificial intelligence or machine learning system.

Clause 18. The method of any of Clauses 11-17, further comprising automatically operating the aircraft according to the updated flight plan.

Clause 19. The method of any of Clauses 11-18, wherein said automatically operating is performed by the control unit.

Clause 20. A system comprising:
an aircraft including a user interface including a display in communication with an input device, wherein the user interface is configured to be operated by a pilot of the aircraft to input an issue in relation to a flight plan for the aircraft;
a communication device; and
a control unit in communication with the communication device, wherein the control unit is an artificial intelligence or machine learning system, and wherein the control unit is configured to:
   receive, via the communication device, an issue signal including information regarding the issue in relation to the flight plan for the aircraft,
   compare the issue with data from flight information sources to automatically validate the issue, wherein the flight information sources comprise a tracking sub-system configured to track the aircraft; a weather sub-system configured to provide past, current, and predicted weather; aircraft data sources configured to provide information about the aircraft; and a historical database configured to provide data regarding issues reported from one or both of the aircraft or other aircraft; and
   in response to the issue being automatically validated, automatically update the flight plan based on the issue to provide an updated flight plan,
wherein the aircraft is configured to be operated according to the updated flight plan.

As described herein, examples of the present disclosure provide systems and methods for efficiently and effectively updating aeronautical data for flight plans of aircraft. Further, examples of the present disclosure provide systems and methods for automatically updating (without human intervention) the aeronautical data. Additionally, examples of the present disclosure provide systems and methods for quickly updating flight plans.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a communication device; and
a control unit in communication with the communication device, wherein the control unit is configured to:
receive, via the communication device, an issue signal including information regarding an issue in relation to a flight plan for an aircraft,
compare the issue with data from one or more flight information sources to automatically validate the issue, and
in response to the issue being automatically validated, automatically update the flight plan based on the issue to provide an updated flight plan.

2. The system of claim 1, wherein the aircraft is configured to be operated according to the updated flight plan.

3. The system of claim 1, wherein the aircraft comprises a user interface including a display in communication with an input device, wherein the issue is input by a pilot of the aircraft via the user interface.

4. The system of claim 1, wherein the one or more flight information sources comprise one or more of:
a tracking sub-system configured to track the aircraft;
a weather sub-system configured to provide past, current, and predicted weather;
aircraft data sources configured to provide information about the aircraft; or
a historical database configured to provide data regarding issues reported from one or both of the aircraft or other aircraft.

5. The system of claim 4, wherein the one or more flight information sources comprise the tracking sub-system, the weather sub-system, the aircraft data sources, and the historical database.

6. The system of claim 5, wherein the tracking sub-system is an automatic dependent surveillance-broadcast (ADS-B) tracking sub-system.

7. The system of claim 5, wherein the aircraft data sources provide tail-specific information regarding the aircraft.

8. The system of claim 1, wherein the control unit is an artificial intelligence or machine learning system.

9. The system of claim 1, wherein the aircraft is automatically operated according to the updated flight plan.

10. The system of claim 9, wherein the control unit is further configured to automatically operate the aircraft according to the updated flight plan.

11. A method comprising:
communicatively coupling a control unit with a communication device;
receiving, by the control unit via the communication device, an issue signal including information regarding an issue in relation to a flight plan for an aircraft;
comparing, by the control unit, the issue with data from one or more flight information sources to automatically validate the issue; and
in response to the issue being automatically validated, automatically updating the flight plan based on the issue to provide an updated flight plan.

12. The method of claim 11, further comprising operating the aircraft according to the updated flight plan.

13. The method of claim 11, further comprising inputting, via a user interface of the aircraft, the issue by a pilot of the aircraft.

14. The method of claim 11, wherein the one or more flight information sources comprise one or more of:
a tracking sub-system configured to track the aircraft;
a weather sub-system configured to provide past, current, and predicted weather;
aircraft data sources configured to provide information about the aircraft; or
a historical database configured to provide data regarding issues reported from one or both of the aircraft or other aircraft.

15. The method of claim 14, wherein the one or more flight information sources comprise the tracking sub-system, the weather sub-system, the aircraft data sources, and the historical database.

16. The method of claim 15, wherein the tracking sub-system is an automatic dependent surveillance-broadcast (ADS-B) tracking sub-system, and wherein the aircraft data sources provide tail-specific information regarding the aircraft.

17. The method of claim 11, wherein the control unit is an artificial intelligence or machine learning system.

18. The method of claim 11, further comprising automatically operating the aircraft according to the updated flight plan.

19. The method of claim 18, wherein said automatically operating is performed by the control unit.

20. A system comprising:
an aircraft including a user interface including a display in communication with an input device, wherein the user interface is configured to be operated by a pilot of the aircraft to input an issue in relation to a flight plan for the aircraft;
a communication device; and
a control unit in communication with the communication device, wherein the control unit is an artificial intelligence or machine learning system, and wherein the control unit is configured to:
receive, via the communication device, an issue signal including information regarding the issue in relation to the flight plan for the aircraft,
compare the issue with data from flight information sources to automatically validate the issue, wherein the flight information sources comprise a tracking sub-system configured to track the aircraft; a weather sub-system configured to provide past, current, and predicted weather; aircraft data sources configured to provide information about the aircraft; and a historical database configured to provide data regarding issues reported from one or both of the aircraft or other aircraft; and
in response to the issue being automatically validated, automatically update the flight plan based on the issue to provide an updated flight plan,
wherein the aircraft is configured to be operated according to the updated flight plan.
